(19) United States
(12) Patent Application Publication
(10) Pub. No.: US 2013/0321357 A1
(43) Pub. Date: Dec. 5, 2013

(54) DISPLAY PANEL AND DISPLAY DEVICE

(71) Applicant: PANASONIC CORPORATION, Osaka (JP)

(72) Inventors: Kazuhiro YAMADA, Osaka (JP); Eiichi NAGAOKA, Hyogo (JP)

(21) Appl. No.: 13/907,671

(22) Filed: May 31, 2013

(30) Foreign Application Priority Data
Jun. 1, 2012 (JP) 2012-125730
Apr. 24, 2013 (JP) 2013-091306

(51) Int. Cl. G06F 3/0354

(52) U.S. Cl. CPC G06F 3/03545
USPC 345/179

(57) ABSTRACT

In a display panel 24, each of information patterns is formed by using marks 42 each arranged on the basis of, as a virtual reference point, a grid point in a virtual grid. The marks include first marks 42a each arranged at one side of a target direction with respect to a virtual reference point 60a and second marks 42b each arranged at another side of the target direction with respect to a virtual reference point 60b. Where a pitch between the virtual reference lines is P; a width of a black line 31a is W; widths of the first mark and the second mark in the target direction are D1 and D2, respectively; and distances in the target direction from center positions of the first mark and the second mark to the virtual reference points are S1 and S2, respectively, a relational expression of P>W+D1/2+D2/2+S1+S2 is met.

### BACKGROUND

1. Field

The present disclosure relates to a display panel for use in a display device that enables a handwriting input on a display surface of a digital display, and the like.

2. Description of the Related Art

Hitherto, a display device is known which enables a handwriting input on a display surface of a digital display.

Japanese Laid-Open Patent Publication No. 2007-226577 describes a technology in which when characters or the like are written on paper with a pen, the information written on the paper is computerized and transmitted to a server or a terminal.

### SUMMARY

Meanwhile, in recent years, a system has been developed which enables such a handwriting input that when a character or the like is written on a display area of a display device with a writing tool such as a stylus, the handwriting made with the writing tool on the display is displayed on the display surface. However, such a system is still under development. In particular, there is still room for development in terms of highly fine handwriting input.

As one of such systems, a display control system is conceivable which: includes a display device having a display area for displaying an image and a pointing device for pointing to a position on the display area; and performs display control in accordance with the position, on the display area, which is pointed to by the pointing device. In the display control system, information patterns (position information patterns) each representing information regarding a position on the display area are provided on the display area, the pointing device reads the information pattern at the pointed position on the display area, and the display device performs trajectory display or the like in accordance with the read information pattern.

However, in such a display control system, in the display area, pixels are separated from each other by a black matrix. Thus, when an information pattern is read, there is a concern that the information pattern is not accurately read due to influence of the black matrix.

The present disclosure is made in view of the above-described point and provides a display panel having improved accuracy of reading an information pattern.

A display panel according to the present disclosure has a display area for displaying an image. The display panel includes: a black stripe separating a plurality of pixels for forming a display image displayed on the display area; and a plurality of information patterns arranged on the display area and each representing information regarding a position thereof on the display area. Each information pattern is formed in a grid formed by using a plurality of virtual reference lines parallel to or substantially parallel to a plurality of black lines constituting the black stripe, by using a plurality of marks each arranged on the basis of a grid point in the grid as a virtual reference point. The plurality of marks include a plurality of first marks each arranged at one side of a target direction, perpendicular to the virtual reference line, with respect to the virtual reference point and a plurality of second marks each arranged at another side of the target direction with respect to the virtual reference point. Where a pitch between the virtual reference lines in the target direction is P; a width of the black line of the black stripe is W; a width of the first mark in the target direction is D1; a width of the second mark in the target direction is D2; a distance in the target direction from a center position of the first mark in the target direction to the virtual reference point of the first mark is S1; and a distance in the target direction from a center position of the second mark in the target direction to the virtual reference point of the second mark is S2, a relational expression of P>W+D1/2+D2/2+S1+S2 is met.

According to the display panel of the present disclosure, it is possible to improve accuracy of reading an information pattern.

### BRIEF DESCRIPTION OF THE DRAWINGS

FIG. 1 is a schematic diagram showing a situation where a user uses a display control system 100;

FIG. 2 is a block diagram of the display control system 100;

FIG. 3 is a schematic cross-sectional view of a display panel 24;

FIG. 4 is a schematic diagram showing a cross section of a digital pen 10;

FIG. 5 is an enlarged view of an optical film 40 for explaining a dot pattern;

FIG. 6 is a schematic diagram for explaining that information obtained by numeric conversion of the position of a dot 42 is different depending on the position of the dot 42 with respect to a virtual reference point;

FIG. 7 is an enlarged view of a display section 21;

FIG. 8 is a diagram for explaining the pitch between each first reference line 44;

FIG. 9 is a flowchart showing flow of a process of the display control system 100;

FIG. 10(a) is a schematic diagram showing dot patterns on a black matrix 31 in a case where the pitch P between each first reference line 44 is not an integral multiple of the pitch Q between each first black line 31a;

FIG. 10(b) is a schematic diagram showing an image of the region shown in FIG. 10(a) which is captured by the digital pen 10;

FIG. 10(c) is a schematic diagram after a binarization process is performed on the image in FIG. 10(b);

FIG. 11(a) is a schematic diagram showing dot patterns on the black matrix 31 in a case where the pitch P between each first reference line 44 is an integral multiple of the pitch Q between each first black line 31a;

FIG. 11(b) is a schematic diagram showing an image of the region shown in FIG. 11(a) which is captured by the digital pen 10;

FIG. 11(c) is a schematic diagram after a binarization process is performed on the image in FIG. 11(b);

FIG. 12 is a schematic diagram showing a cross section of a digital pen 110 according to another embodiment;

FIG. 13 is a block diagram of a display control system 200 according to another embodiment;

FIG. 14 is a flowchart showing flow of a process of the display control system 200 according to the other embodiment; and

FIG. 15 is a schematic diagram showing a dot pattern according to another embodiment.

### DETAILED DESCRIPTION

Hereinafter, embodiments will be described in detail with reference to the drawings as appropriate. However, there will be instances in which detailed description beyond what is necessary is omitted. For example, detailed description of subject matter that is previously well-known, as well as redundant description of components that are substantially the same will in some cases be omitted. This is to prevent the following description from being unnecessarily lengthy, in order to facilitate understanding by a person of ordinary skill in the art.

The inventors provide the following description and the accompanying drawings in order to allow a person of ordinary skill in the art to sufficiently understand the present disclosure, and the description and the drawings are not intended to restrict the subject matter of the scope of the patent claims.

### Embodiment 1

Hereinafter, Embodiment 1 will be described in detail with reference to the drawings.

[1.Outline of Display Control System]

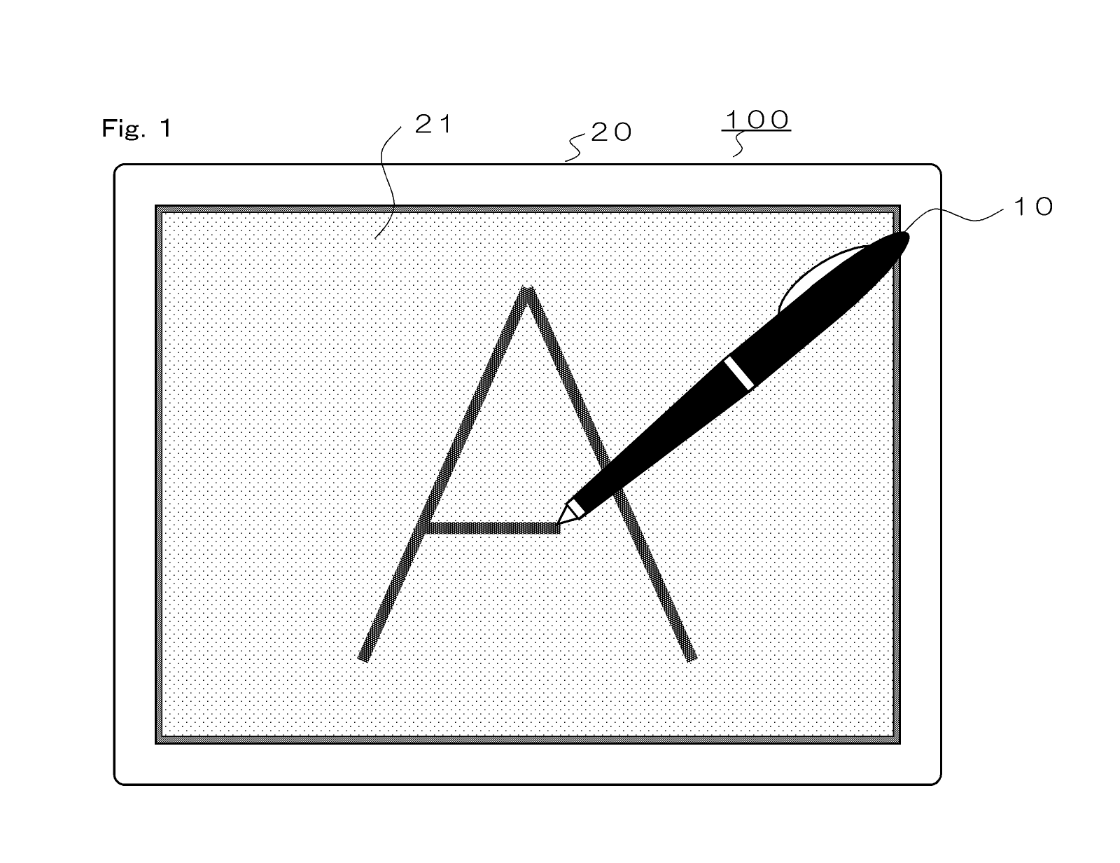

FIG. 1 is a schematic diagram showing the appearance of a display control system 100 according to the present embodiment. The display control system 100 includes an optical digital pen (hereinafter, referred to merely as “digital pen”) 10 and a display device 20. Although described in detail later, the display device 20 is a liquid crystal display capable of displaying various images on a display section 21 (a display area). In addition, the display device 20 is provided with dot patterns each representing information regarding a position on the display section 21. The digital pen 10 detects information regarding a position of the tip of the digital pen 10 on the display section 21 (hereinafter, also referred to as “position information”) by optically reading a dot pattern, and transmits the position information to the display device 20. The display device 20 receives the position information as an input and performs various display control.

For example, when the tip of the digital pen 10 is moved on the display section 21, the digital pen 10 detects continuous position information as a trajectory of the tip of the digital pen 10 from continuously read dot patterns. The display device 20 continuously displays spots on the display section 21 in accordance with the trajectory of the tip of the digital pen 10. By so doing, it is possible to perform a handwriting input of a character, a figure, or the like on the display section 21 by using the digital pen 10. Or the display device 20 continuously deletes spots displayed on the display section 21, in accordance with the trajectory of the tip of the digital pen 10. By so doing, it is possible to delete a character, a figure, or the like on the display section 21 by using the digital pen 10 like an eraser. In other words, the digital pen 10 serves as a reading device and also serves as an input device that performs an input to the display control system 100.

[2.Configuration of Display Device]

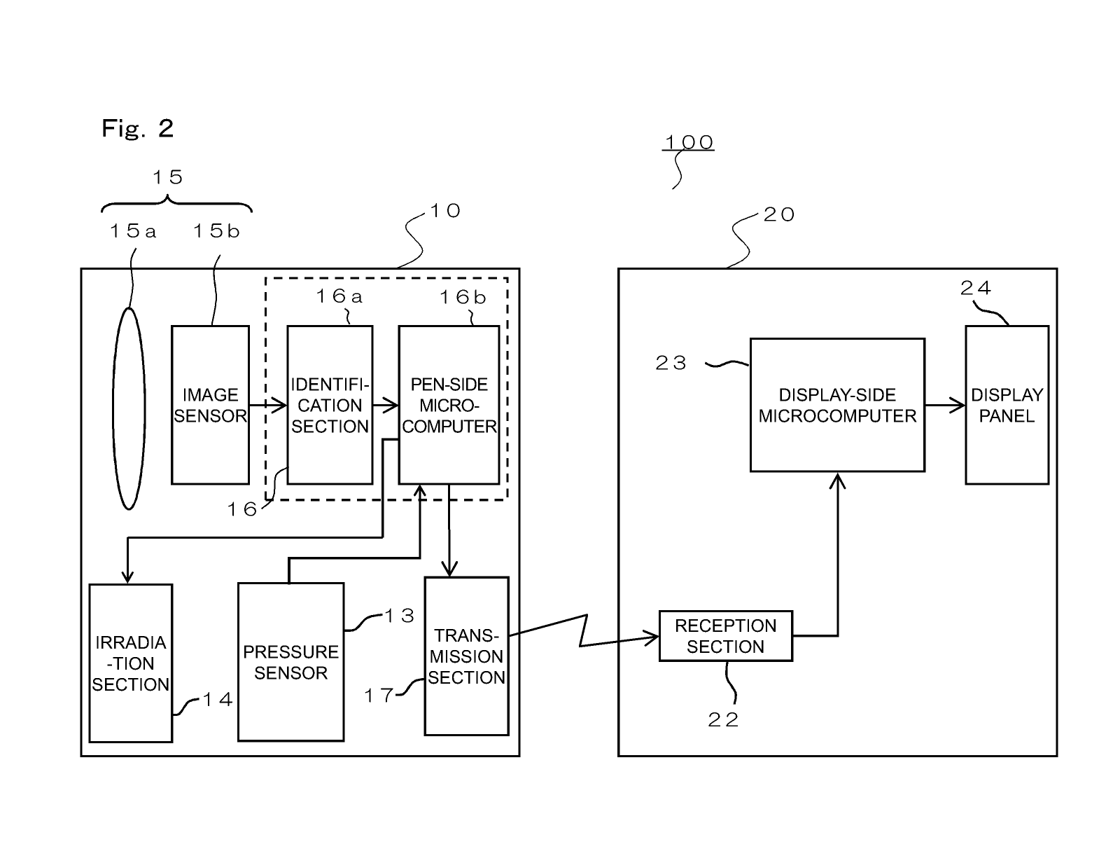

Hereinafter, the display device 20 will be described. FIG. 2 is a block diagram showing a schematic configuration of the display control system 100.

The display device 20 includes a reception section 22 that receives a signal from an external device, a display-side microcomputer 23 (a display control section) that controls the entirety of the display device 20, and a display panel 24 that includes the display section 21 that displays an image.

Although described in detail later, the reception section 22 receives a signal transmitted from the digital pen 10. The signal received by the reception section 22 is transmitted to the display-side microcomputer 23.

The display-side microcomputer 23 is composed of a CPU, a memory, and the like. The display-side microcomputer 23 is provided with a program for causing the CPU to operate. For example, the display-side microcomputer 23 controls the display panel 24 on the basis of a signal transmitted from the digital pen 10 and changes a content displayed on the display panel 24.

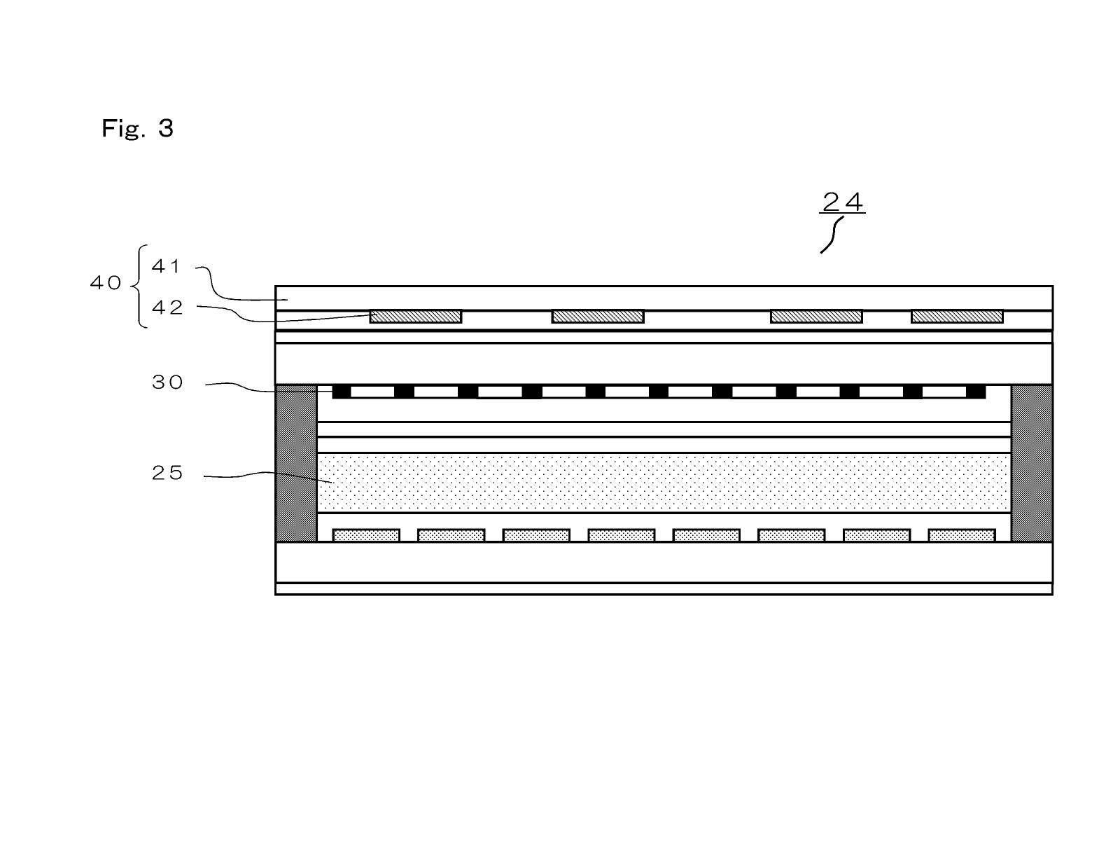

FIG. 3 is a schematic cross-sectional view of the display panel 24. The display panel 24 is a liquid crystal panel. The basic configuration of the display panel 24 is the same as the configuration of a general liquid crystal panel, except an optical film 40. The display panel 24 mainly includes a liquid crystal layer 25, a color filter 30, and the optical film 40.

The optical film 40 includes a PET film 41 as a base material and dot patterns composed of a plurality of dots 42.

The plurality of dots 42 are arranged on a back surface (a lower surface in FIG. 3) of the PET film 41. One dot pattern is formed of a set of dots 42 within a unit area 50 described later. On the PET film 41, a plurality of dot patterns are formed. Each dot pattern is an example of an information pattern representing information regarding the position of the dot pattern on the display area. Each dot 42 is an example of a mark. In addition, the PET film 41 is an example of a base material.

The display device 20 also includes, for example, a backlight unit (not shown) that applies light from a back side of the display panel 24 to the display panel 24. The backlight unit includes, on a back side of its light source, a diffuse reflection sheet that diffusely reflects light incident thereon from a side of the display panel 24.

[3. Configuration of Digital Pen]

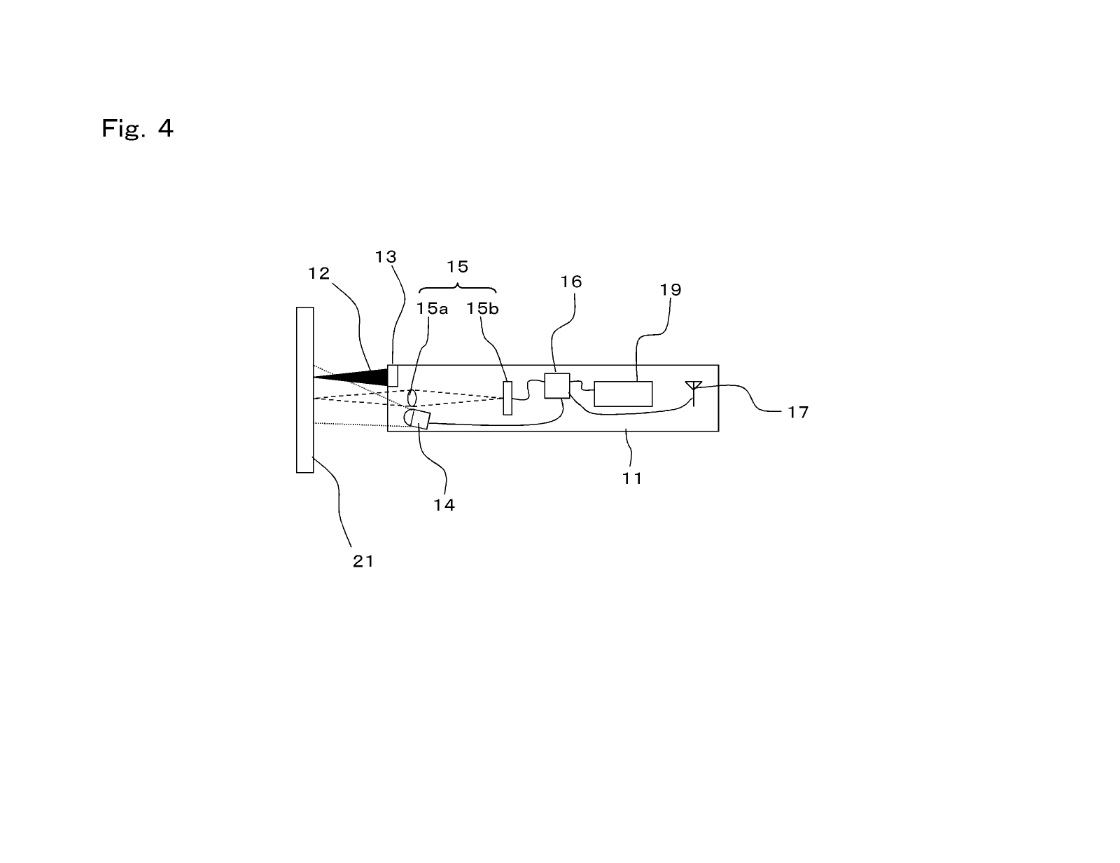

Next, a detailed configuration of the digital pen 10 will be described. FIG. 4 is a schematic diagram showing a cross section of the digital pen 10.

The digital pen 10 includes a cylindrical body case 11, a pen tip portion 12 that is attached to an end of the body case 11, a pressure sensor 13 that detects a pressure applied to the pen tip portion 12, an irradiation section 14 that emits infrared light, a reading section 15 that optically reads infrared light incident thereon, a control section 16 that controls the digital pen 10, a transmission section 17 that outputs a signal to an external device, and a power supply 19 that supplies power to each component of the digital pen 10.

The body case 11 has an outer shape similar to that of a general pen and is formed in a cylindrical shape. The pen tip portion 12 is formed in a tapered shape. The tip of the pen tip portion 12 is rounded to such an extent that the tip does not damage the surface of the display panel 24. It should be noted that the pen tip portion 12 preferably has such a shape that the user is allowed to easily recognize an image displayed on the display section 21.

The pressure sensor 13 is provided within the body case 11 and is connected to a base portion of the pen tip portion 12. The pressure sensor 13 detects a pressure applied to the pen tip portion 12 and transmits the detection result to the control section 16. Specifically, the pressure sensor 13 detects a pressure applied from the display panel 24 to the pen tip portion 12 when the user writes a character or the like on the display surface of the display panel 24 with the digital pen 10. In other words, the pressure sensor 13 is used when it is determined whether the user intends to perform an input with the digital pen 10.

The irradiation section 14 is provided in an end portion of the body case 11 near the pen tip portion 12. The irradiation section 14 is composed of, for example, an infrared LED. The irradiation section 14 is provided so as to emit infrared light from the end of the body case 11.

The reading section 15 includes an objective lens 15a and an image sensor 15b. The objective lens 15a causes light, incident thereon from the pen tip side, to form an image on the image sensor 15b. The objective lens 15a is provided in the end portion of the body case 11 near the pen tip portion 12. Here, when infrared light is emitted from the irradiation section 14 in a state where the tip of the digital pen 10 is directed to the display surface of the display device 20, the infrared light passes through the display panel 24 and is diffusely reflected on the diffuse reflection sheet located on the back side of the display panel 24. As a result, regardless of the angle of the digital pen 10, part of the infrared light having passed through the display panel 24 returns to the digital pen 10 side. The infrared light that is emitted from the irradiation section 14 and diffusely reflected on the display device 20 is incident on the objective lens 15a. The image sensor 15b is provided on the optical axis of the objective lens 15a. Thus, the infrared light having passed through the objective lens 15a is caused to form an image on an imaging surface of the image sensor 15b. The image sensor 15b converts the optical image formed on the imaging surface to an electrical signal to generate an image signal, and outputs the image signal to the control section 16. The image sensor 15b is composed of, for example, a CCD image sensor or a CMOS image sensor. Although described in detail later, the dot patterns are formed from a material that absorbs infrared light (a material having a low transmittance for infrared light). Thus, almost no infrared light returns from the dots 42 of the dot patterns to the digital pen 10. On the other hand, a more amount of infrared light returns from the region between each dot 42 than from the region of each dot 42. As a result, an optical image in which a dot pattern is represented in black is captured by the image sensor 15b.

As shown in FIG. 2, the control section 16 includes an identification section 16a and a pen-side microcomputer 16b. The identification section 16a identifies position information of the digital pen 10 on the display section 21 on the basis of an image signal from the reading section 15. Specifically, the identification section 16a obtains the pattern shape of a dot pattern from an image signal obtained by the reading section 15, and identifies a position, on the display section 21, of the pen tip portion 12 on the basis of the pattern shape. Information regarding the position of the pen tip portion 12 which is identified by the identification section 16a is transmitted to the pen-side microcomputer 16b. The pen-side microcomputer 16b controls the entirety of the digital pen 10. The pen-side microcomputer 16b is composed of a CPU, a memory, and the like and is provided with a program for causing the CPU to operate.

The transmission section 17 transmits a signal to an external device. Specifically, the transmission section 17 wirelessly transmits the position information identified by the identification section 16a, to an external device. The transmission section 17 performs short-distance wireless communication with the reception section 22 of the display device 20. The transmission section 17 is provided in an end portion of the body case 11 which is opposite to the pen tip portion 12.

[4. Details of Dot Patterns]

Hereinafter, the dot patterns will be described in detail.

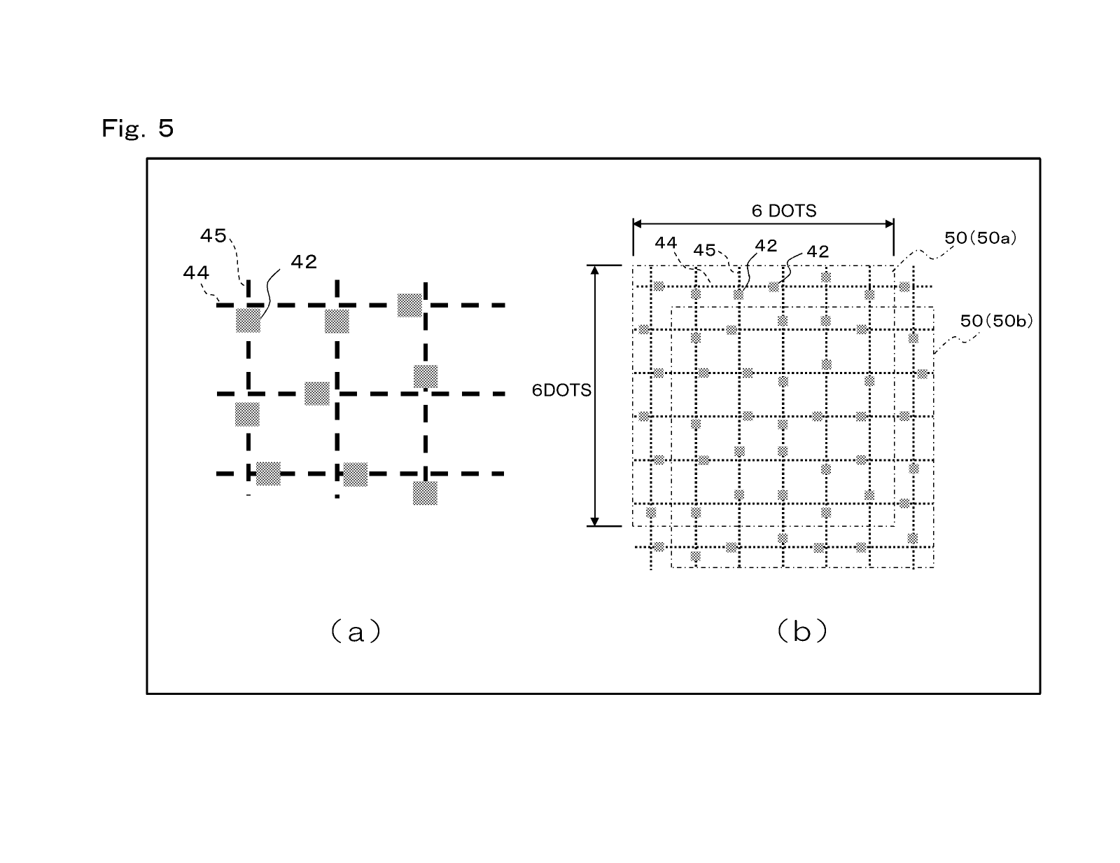

The dot patterns will be described with reference to FIG. 5. FIG. 5 is an enlarged view when the optical film 40 is seen from the . In FIGS. 5(a) and 5(b), for explaining the position of each dot 42 of each dot pattern, first reference lines 44 and second reference lines 45 are shown as virtual lines (lines that do not actually exist on the optical film 40) on the optical film 40. The first reference lines 44 and the second reference lines 45 are perpendicular to each other. In FIG. 5, a grid is formed of a plurality of the first reference lines 44 arranged, for example, at equal intervals and a plurality of the second reference lines 45 arranged, for example, at equal intervals. Each first reference line 44 is an example of a virtual reference line. The grid-like pattern composed of the first reference lines 44 and the second reference lines 45 is an example of a virtual reference pattern.

The position where each dot 42 is arranged is associated with the grid-like pattern composed of the first reference lines 44 and the second reference lines 45. Specifically, the position where each dot 42 is arranged is associated with the intersection (grid point) of the first reference line 44 and the second reference line 45. In other words, each of a plurality of the dots 42 is arranged in the grid formed by using a plurality of the first reference lines 44 and a plurality of the second reference lines 45, on the basis of a grid point in the grid as a virtual reference point. As shown in FIG. 5, each dot 42 is arranged around the intersection of the first reference line 44 and the second reference line 45. Each dot 42 is arranged near each grid point.

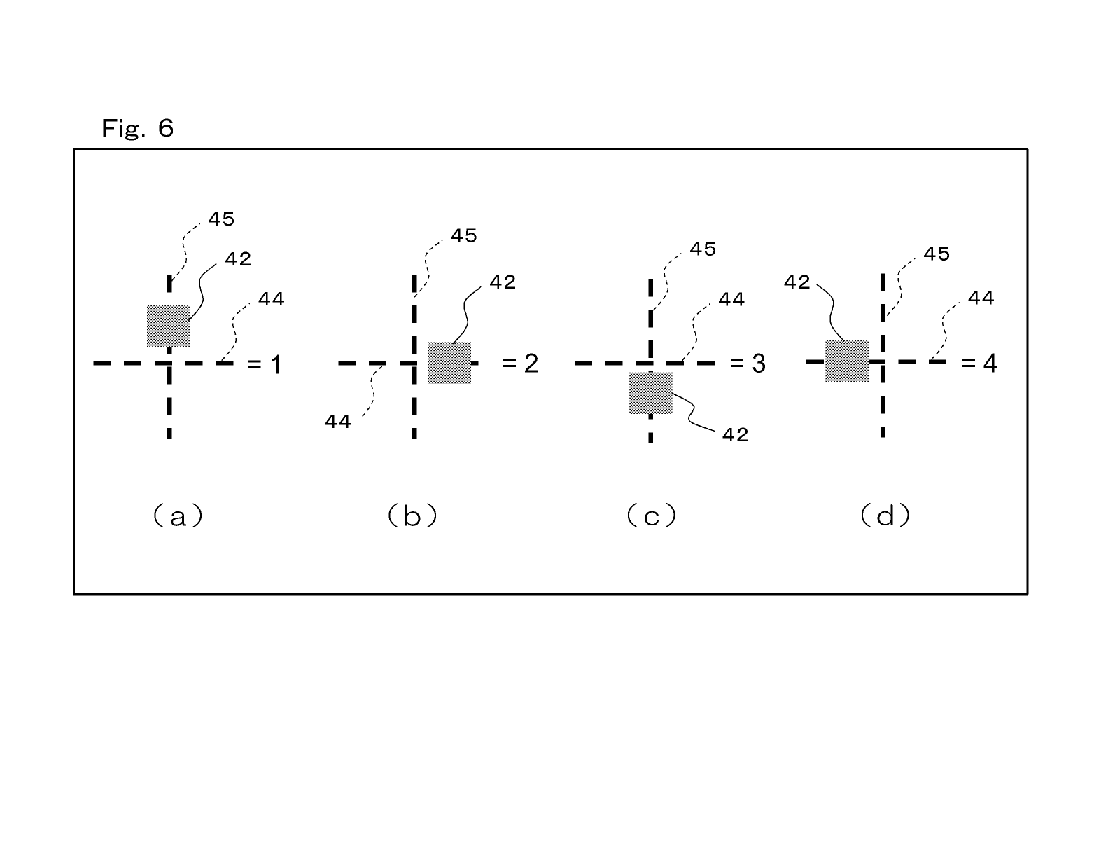

FIG. 6 is a diagram showing arrangement patterns of each dot 42. Where the direction in which each first reference line 44 extends is an X direction and the direction in which each second reference line 45 extends is a Y direction, each dot 42 is arranged at a position shifted from the intersection of the first reference line 44 and the second reference line 45 along the X direction or the Y direction toward the plus side or the minus side. Specifically, on the optical film 40, each dot 42 is arranged as shown in any of FIGS. 6(a) to 6(d). In the arrangement of FIG. 6(a), the dot 42 is arranged at a position above the intersection of the first reference line 44 and the second reference line 45. This arrangement is represented by “1” when numeric conversion is performed thereon. In the arrangement of FIG. 6(b), the dot 42 is arranged at a position on the right side of the intersection of the first reference line 44 and the second reference line 45. This arrangement is represented by “2” when numeric conversion is performed thereon. In the arrangement of FIG. 6(c), the dot 42 is arranged at a position below the intersection of the first reference line 44 and the second reference line 45. This arrangement is represented by “3” when numeric conversion is performed thereon. In the arrangement of FIG. 6(d), the dot 42 is arranged at a position on the left side of the intersection of the first reference line 44 and the second reference line 45. This arrangement is represented by “4” when numeric conversion is performed thereon. Each dot 42 is represented by a number of “1” to “4” in the digital pen 10 in accordance with the arrangement pattern.

Then, as shown in FIG. 5(b), 6 dots×6 dots are set as one unit area 50, and one dot pattern is formed of the 36 dots 42 included in a unit area 50. By arranging each of the 36 dots 42, included in each unit area 50, at any of “1” to “4” shown in FIG. 6, it is possible to form a huge number of dot patterns having information different from each other. All the dot patterns (the dot patterns in the unit areas 50) on the optical film 40 are different from each other.

Information is added to each dot pattern on the optical film 40. Specifically, each dot pattern represents a position coordinate of each unit area 50. In other words, when the optical film 40 is divided in the unit areas 50 of 6 dots×6 dots, each dot pattern represents a position coordinate of the corresponding unit area 50. In FIG. 5(b), a dot pattern in an area 50a represents a position coordinate of the center position of the area 50a, and a dot pattern in an area 50b represents a position coordinate of the center position of the area 50b. When the pen tip moves diagonally downward right in FIG. 5(b), an area 50 read by the digital pen 10 is changed from the area 50a to the area 50b. As the method for patterning (coding) and coordinate transformation (decoding) of dot patterns as described above, for example, a publicly known method disclosed in Japanese Laid-Open Patent Publication No. 2006-141061 may be used.

[5. Material of Dots]

Each dot 42 can be formed from a material that transmits visible light (light having a wavelength of 400 to 700 nm) and absorbs infrared light (light having a wavelength of 700 nm or longer). Each dot 42 is formed from, for example, a material that absorbs infrared light having a wavelength of 800 nm or longer. Specifically, each dot 42 is formed from a material having a transmittance of 90% or higher for visible light and a transmittance of 50% or lower (e.g., 20% or lower) for infrared light. For example, each dot 42 may be formed from a material having a transmittance of 10% or lower for infrared light.

Examples of such materials include diimmonium-based compounds, phthalocyanine-based compounds, and cyanine-based compounds. These materials may be used singly or may be mixed and used. A diimmonium salt-based compound is preferably included as a diimmonium-based compound. The diimmonium salt-based compound absorbs a large amount of light in the near-infrared range, has a wide range of absorption, and has a high transmittance for light in the visible light range. As the diimmonium salt-based compound, a commercially available product may be used, and, for example, KAYASORB series (Kayasorb IRG-022, IRG-023, IRG-024, etc.) manufactured by Nippon Kayaku Co., Ltd. and CIR-1080, CIR-1081, CIR-1083, CIR-1085, etc. manufactured by Japan Carlit Co., Ltd. are preferred. As a cyanine-based compound, a commercially available product may be used, and, for example, TZ series (TZ-103, TZ-104, TZ-105, etc.) manufactured by ADEKA Corporation and CY-9, CY-10, etc. manufactured by Nippon Kayaku Co., Ltd. are preferred.

The case has been described above in which each dot 42 absorbs infrared light (has a low transmittance for infrared light). However, each dot 42 may be formed so as to diffusely reflect infrared light. In such a case, infrared light incident on the optical film 40 from the outside of the display panel 24 is diffusely reflected on each dot 42, and thus part thereof surely reaches the image sensor 15b. The digital pen 10 is allowed to recognize the reflected light from each dot 42. On the other hand, the region between each dot 42 specularly reflects infrared light. From the region between each dot 42, almost no infrared light reaches the image sensor 15b. An optical image in which a dot pattern is represented in white is captured by the image sensor 15b.

[6. Relationship between Black Matrix and Virtual Reference Lines]

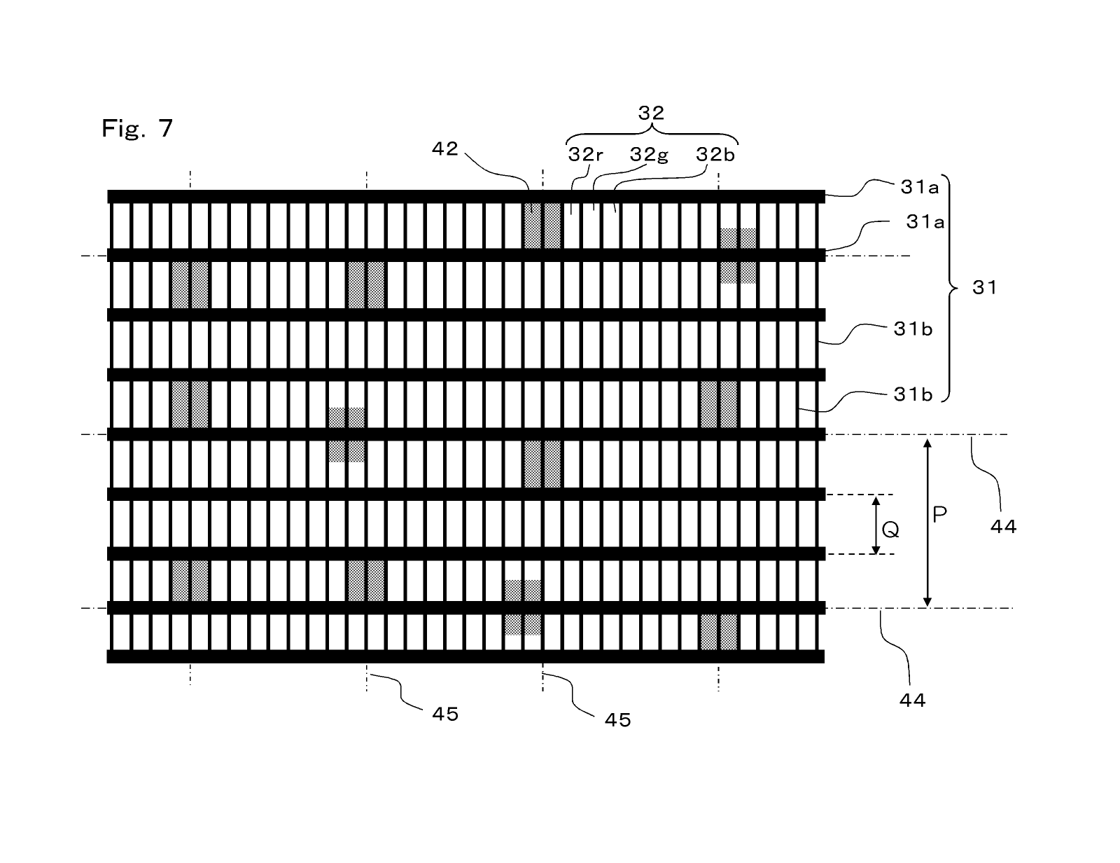

FIG. 7 is an enlarged view of the display section 21. Specifically, FIG. 7 is a view when a state where the color filter 30 and the optical film 40 overlap each other is seen from the front.

A plurality of pixels 32 are provided in the display section 21 (the display area). In the display section 21, the plurality of pixels 32 are arranged in a matrix manner. Each pixel 32 includes a red sub-pixel 32r, a green sub-pixel 32g, and a blue sub-pixel 32b. It should be noted that when the colors are not distinguished from each other, these sub-pixels are referred to merely as “sub-pixels”. Various images are displayed on the display section 21.

A black matrix 31 is formed in a grid shape by a plurality of first black lines 31a (horizontal black lines) and a plurality of second black lines 31b (vertical black lines). Each first black line 31a extends in a first direction of the display surface (in the horizontal direction in FIG. 7). Each first black line 31a extends in a direction in which the three sub-pixels in each pixel 32 are aligned. Each second black line 31b extends in a second direction of the display surface (in the vertical direction in FIG. 7). The black matrix 31 is formed by the first black lines 31a and the second black lines 3 lb vertically and horizontally intersecting each other. The black matrix 31 is formed from a material that contains carbon black as a principal component. The black matrix 31 is formed from a material having high infrared absorption properties. Each first black line 31a is formed so as to be thicker than each second black line 31b. In the black matrix 31, the plurality of first black lines 31a arranged, for example, at equal intervals form a first black stripe, and the plurality of second black lines 31b arranged, for example, at equal intervals form a second black stripe.

Next, the pitch between each first reference line 44 (virtual reference line) will be described.

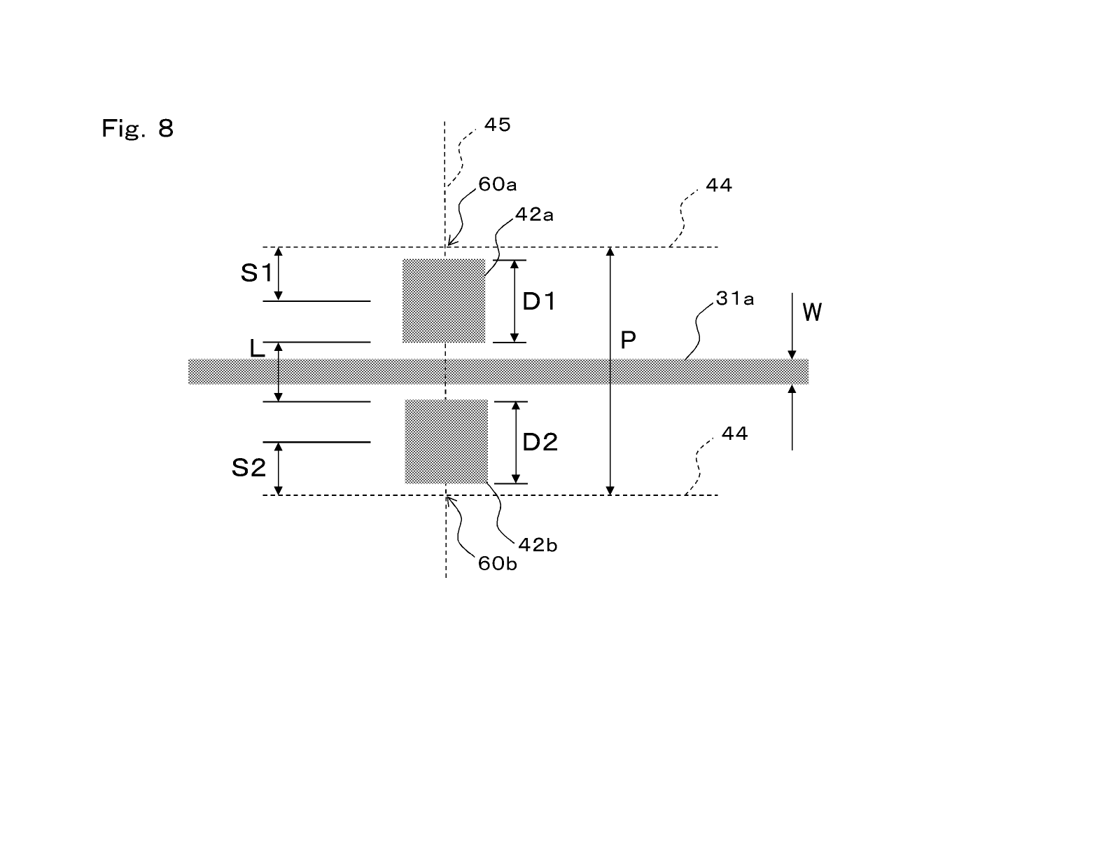

FIG. 8 is a diagram for explaining the pitch between each first reference line 44. It should be noted that when a direction perpendicular to each first reference line 44 (the vertical direction in FIG. 8) is set as a target direction, the plurality of dots 42 include a plurality of first dots 42a (first marks) each arranged at one side (lower side) of the target direction with respect to a corresponding virtual reference point 60a and a plurality of second dots 42b (second marks) each arranged at the other side (upper side) of the target direction with respect to a corresponding virtual reference point 60b. In FIG. 8, P represents the pitch between the first reference lines 44; W represents the width of the first black line 31a; D1 represents the width of the first dot 42a in the target direction; D2 represents the width of the second dot 42b in the target direction; S1 represents the distance in the target direction from the center position of the first dot 42a in the target direction to the virtual reference point 60a; and S2 represents the distance in the target direction from the center position of the second dot 42 in the target direction to the virtual reference point 60b. It should be noted that in FIG. 8, the first reference lines 44 are parallel to the first black line 31a, but the first reference lines 44 may be substantially parallel to the first black line 31a.

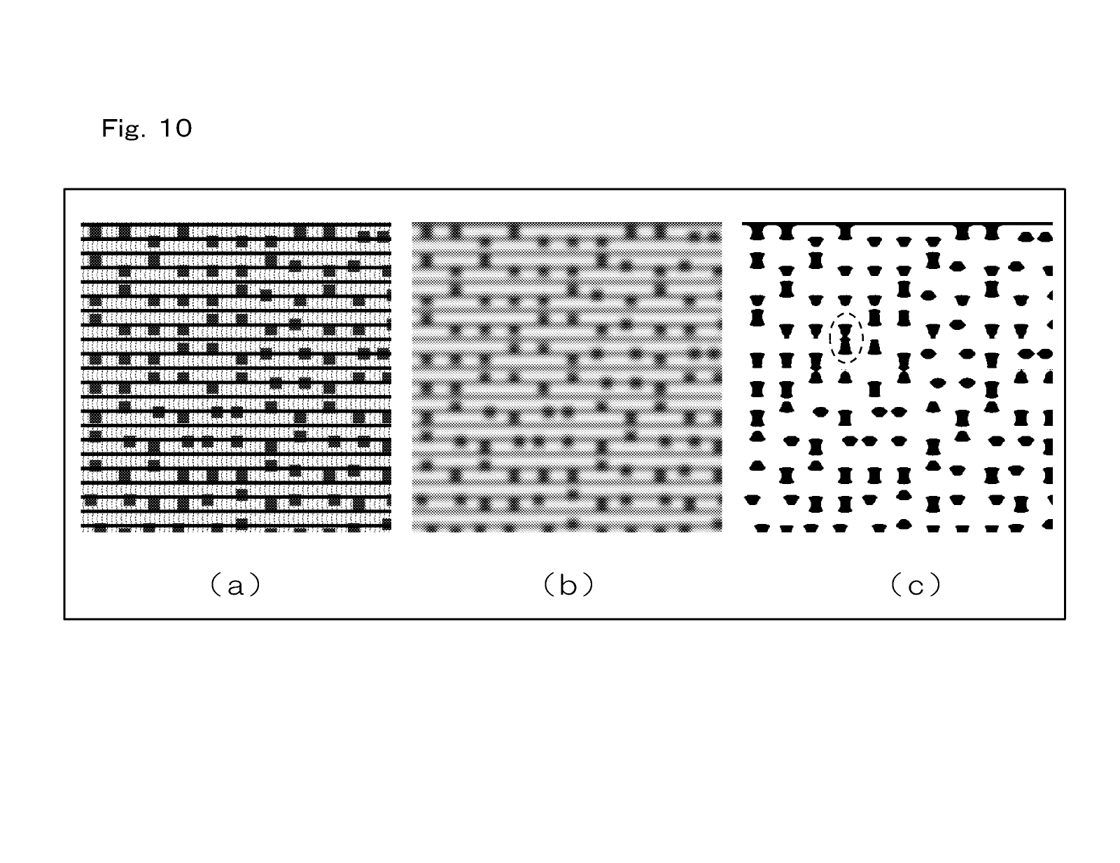

First, a case will be described in which the pitch between each first reference line 44 is shorter than that in FIG. 8. In such a case, in a portion where the second dot 42b is present downwardly adjacent to the first dot 42a on an image captured by the image sensor 15b, the first dot 42a and the second dot 42b are connected to each other, and it becomes difficult to recognize each dot 42. Specifically, on an image in FIG. 10(b) described later, the first black lines 31a are represented in black similarly to the dots 42. Thus, when the second dot 42b is present downwardly adjacent to the first dot 42a across the thicker first black line 31a, the first dot 42a and the second dot 42b are connected to each other via the first black line 31a.

In contrast, in the present embodiment, in order to solve such a problem, the pitch P (the pitch in the target direction) between each first reference line 44 meets a relational expression of formula 1.

P>W+D1/2+D2/2+S1+S2 Formula 1

It should be noted that in the present embodiment, all the dots 42 have the same shape and the same size. In other words, the width D1 of each first dot 42a in the target direction is equal to the width D2 of each second dot 42b in the target direction. In addition, the distance 51 in the target direction from the center position of each first dot 42a in the target direction to the virtual reference point 60a is equal to the distance S2 in the target direction from the center position of each second dot 42b in the target direction to the virtual reference point 60b. Thus, formula 1 is represented as formula 2.

P>W+D1+2×S1 Formula 2

In the present embodiment, since the pitch P between each first reference line 44 meets the relational expression of formula 1, even when the second dot 42b is present downwardly adjacent to the first dot 42a, the distance L between the first dot 42a and the second dot 42b is larger than the width W of the first black line 31a. In other words, it is possible to avoid the first dot 42a and the second dot 42b from being connected to each other via the first black line 31a on the image of the dot pattern.

Next, the pitches of the black matrix 31 and the pitch between each first reference line 44 will be described.

In the present embodiment, the pitch P between each first reference line 44 is set so as to be an integral multiple of the pitch Q between each first black line 31a. The pitch P between each first reference line 44 is preferably set so as to be equal to or larger than three times that of the pitch Q between each first black line 31a. In the present embodiment, the pitch P between each first reference line 44 is three times that of the pitch Q between each first black line 31a. Although described in detail later, it is possible to improve accuracy of reading a dot pattern by the digital pen 10, due to such a configuration.

[7.Operation]

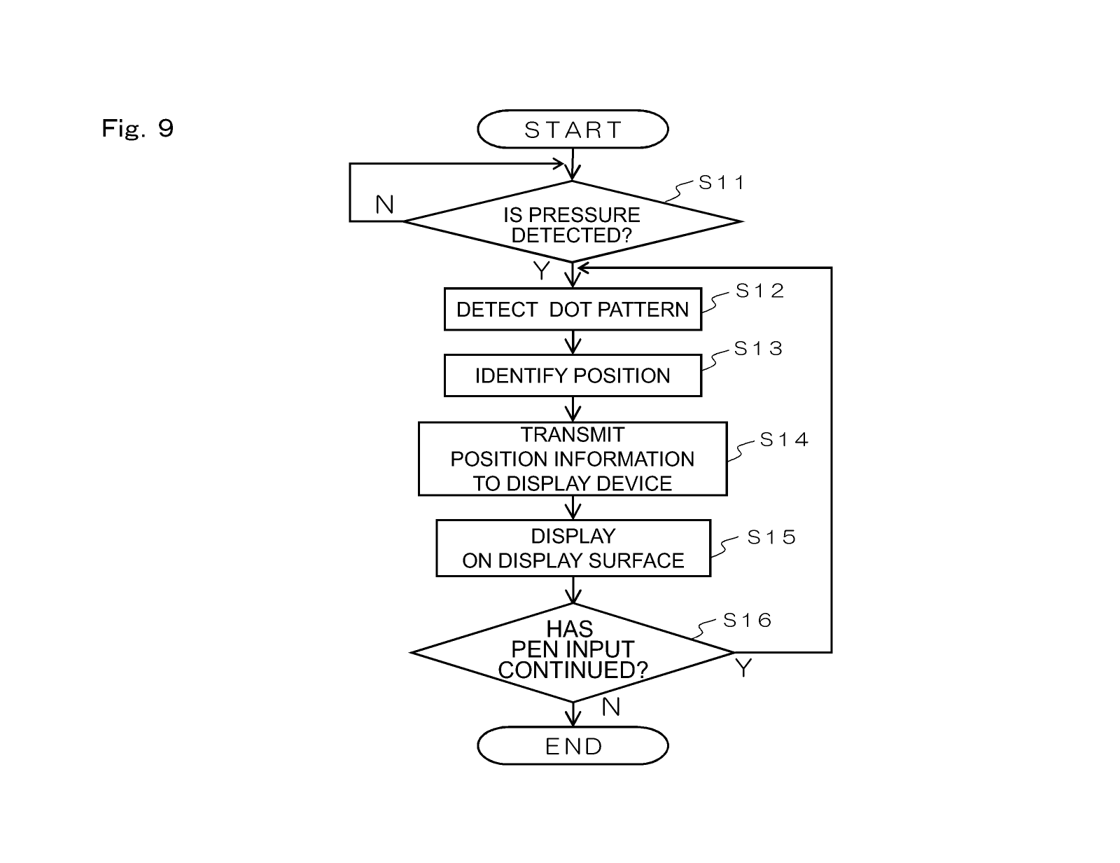

Subsequently, an operation of the display control system 100 configured thus will be described. FIG. 9 is a flowchart showing flow of a process of the display control system 100. Hereinafter, a case will be described in which the user performs a pen input of (writes) a character on the display device 20 with the digital pen 10.

First, when the display control system 100 is turned on, the pen-side microcomputer 16b of the digital pen 10 starts monitoring a pressure applied to the pen tip portion 12 in step S11. The pressure detection is performed by the pressure sensor 13. When a pressure is detected by the pressure sensor 13 (Yes), the pen-side microcomputer 16b determines that the user is performing a pen input of a character or the like on the display section 21 of the display device 20, and the process proceeds to step S12. While no pressure is detected by the pressure sensor 13 (while No continues), the pen-side microcomputer 16b repeats step S11. It should be noted that when the digital pen 10 is turned on, the irradiation section 14 starts emitting infrared light.

In step S12, the reading section 15 of the digital pen 10 detects a dot pattern formed in the display section 21. Here, the infrared light emitted from the irradiation section 14 is diffusely reflected on the above-described diffuse reflection sheet, and part of the infrared light returns to the digital pen 10 side. Then, almost no infrared light returning to the digital pen 10 side passes through the dots 42 of the dot pattern. The infrared light having passed through the region between each dot 42 mainly reaches the objective lens 15a. Then, the infrared light is received by the image sensor 15b via the objective lens 15a. The objective lens 15a is arranged so as to receive reflected light from a position, on the display section 21, which is pointed to by the pen tip portion 12. As a result, an image of the dot pattern at the position, on the display surface of the display section 21, which is pointed to by the pen tip portion 12 is captured by the image sensor 15b. In this manner, the reading section 15 optically reads the dot pattern. An image signal obtained by the reading section 15 is transmitted to the identification section 16a.

In step S13, the identification section 16a obtains the pattern shape of the dot pattern from the image signal, and identifies the position of the pen tip on the display surface of the display section 21 on the basis of the pattern shape. Specifically, the identification section 16a obtains the pattern shape of the dot pattern by performing determined image processing on the obtained image signal. Subsequently, the identification section 16a determines which unit area 50 (unit area of 6 dots×6 dots) the pointed position is located at, from the arrangement of the dots 42 in the obtained pattern shape, and identifies the position coordinate (position information) of the unit area 50 from the dot pattern in the unit area 50. The identification section 16a transforms the dot pattern to the position coordinate by determined calculation corresponding to the method for coding of dot patterns. The identified position information is transmitted to the pen-side microcomputer 16b.

Subsequently, in step S14, the pen-side microcomputer 16b transmits the position information to the display device 20 via the transmission section 17.

The position information transmitted from the digital pen 10 is received by the reception section 22 of the display device 20. The received position information is transmitted from the reception section 22 to the display-side microcomputer 23. In step S15, upon reception of the position information, the display-side microcomputer 23 controls the display panel 24 so as to change a displayed content at a position, on the display surface of the display section 21, corresponding to the position information. In this example, because of character input, a spot is displayed at the position, on the display surface of the display section 21, corresponding to the position information.

Subsequently, in step S16, the pen-side microcomputer 16b determines whether the pen input performed by the user has continued. When the pressure sensor 13 detects a pressure, the pen-side microcomputer 16b determines that the pen input performed by the user has continued, and the process returns to step S12. Then, by repeating a flow of steps S12 to S16, spots are continuously displayed at the position of the pen tip portion 12 on the display surface of the display section 21 so as to follow movement of the pen tip portion 12 of the digital pen 10. At the end, a character corresponding to the trajectory of the pen tip portion 12 of the digital pen 10 is displayed on the display section 21 of the display device 20.

On the other hand, in step S16, when the pressure sensor 13 detects no pressure, the pen-side microcomputer 16b determines that the pen input performed by the user has not continued, and the process is ended.

As described above, the display device 20 displays, on the display section 21, the trajectory of the tip of the digital pen 10 on the display surface of the display section 21. By so doing, it is possible to perform a handwriting input on the display section 21 with the digital pen 10.

It should be noted that the case has been described above in which a character is written, but the use of the display control system 100 is not limited thereto. Needless to say, other than characters (numbers etc.), it is possible to write symbols, figures, and the like. In addition, it is also possible to delete a character, a figure, or the like displayed on the display section 21 by using the digital pen 10 like an eraser. In other words, the display device 20 continuously deletes a display image at the position of the tip of the digital pen 10 on the display section 21 so as to follow movement of the tip of the digital pen 10, whereby it is possible to delete the display image at the portion corresponding to the trajectory of the tip of the digital pen 10 on the display section 21. Furthermore, it is also possible to move a cursor displayed on the display section 21 or select an icon displayed on the display section 21, by using the digital pen 10 like a mouse. In other words, it is possible to operate a graphical user interface (GUI) by using the digital pen 10. As described above, in the display control system 100, an input to the display device 20 is performed in accordance with a position, on the display section 21, which is pointed to by the digital pen 10, and the display device 20 performs various display control in accordance with the input.

[8.Advantageous Effects of Present Embodiment]

In the present embodiment, the pitch P between each first reference line 44 meets the relational expression of formula 1 as described above. Thus, even when the second dot 42b is present downwardly adjacent to the first dot 42a, it is possible to avoid the first dot 42a and the second dot 42b from being connected to each other via the first black line 31a on the image of the dot pattern.

It should be noted that the pitch P between each first reference line 44 may meet a relational expression of formula 3.

P>1.1×(W+D1/2+D2/2+S1+S2) Formula 3

Thus, even when a captured image of a dot pattern is blurred due to influence of an optical system or the like, it is possible to avoid the first dot 42a and the second dot 42b from being connected to each other via the first black line 31a.

In addition, as described above, the pitch P between each first reference line 44 is set so as to be an integral multiple of the pitch Q between each first black line 31a. Specifically, the pitch P between each first reference line 44 is three times that of the pitch Q between each first black line 31a. The reason why the accuracy of reading a dot pattern by the digital pen 10 is improved due to such a configuration will be described.

First, a description will be given with, as an example, a case where the pitch P between each first reference line 44 is not an integral multiple of the pitch Q between each first black line 31a. FIG. 10 is a diagram showing the positional relationship between dot patterns and the black matrix 31 in a case where the pitch P between each first reference line 44 is 2.3 times that (is not an integral multiple) of the pitch Q between each first black line 31a.

FIG. 10(a) is a schematic diagram showing the dot patterns on the black matrix 31. FIG. 10(b) is a schematic diagram showing an image of the region shown in FIG. 10(a) which is captured by the digital pen 10. FIG. 10(c) is a schematic diagram after a binarization process (a process of representing image data using a value for black and a value for white) is performed on the image in FIG. 10(b).

As shown in FIG. 10(c), when the interval between the adjacent dots 42 is sufficiently large, the adjacent dots 42 are spaced apart from each other even after the binarization process. Thus, it is possible to individually recognize the adjacent dots 42. However, when the interval between the adjacent dots 42 is small and the first black line 31a is present between the adjacent dots 42, a shape in which the two dots 42 and the first black line 31a are connected to each other is provided as in a region surrounded by a broken line in FIG. 10(c), as a result of the binarization process. When the shapes of the dots 42 are greatly changed as a result of the binarization process, it is impossible to accurately read the position information provided to each dot pattern.

In addition, when the pitch P between each first reference line 44 is not an integral multiple of the pitch Q between each first black line 31a, a manner in which the dots 42 and the first black lines 31a overlap each other is different depending on a location. Thus, the shapes of the dots 42 become varied after the binarization process, and it is impossible to accurately read the position information provided to each dot pattern.

Thus, in the present embodiment, the pitch P between each first reference line 44 is set so as to be three times that of the pitch Q between each first black line 31a.

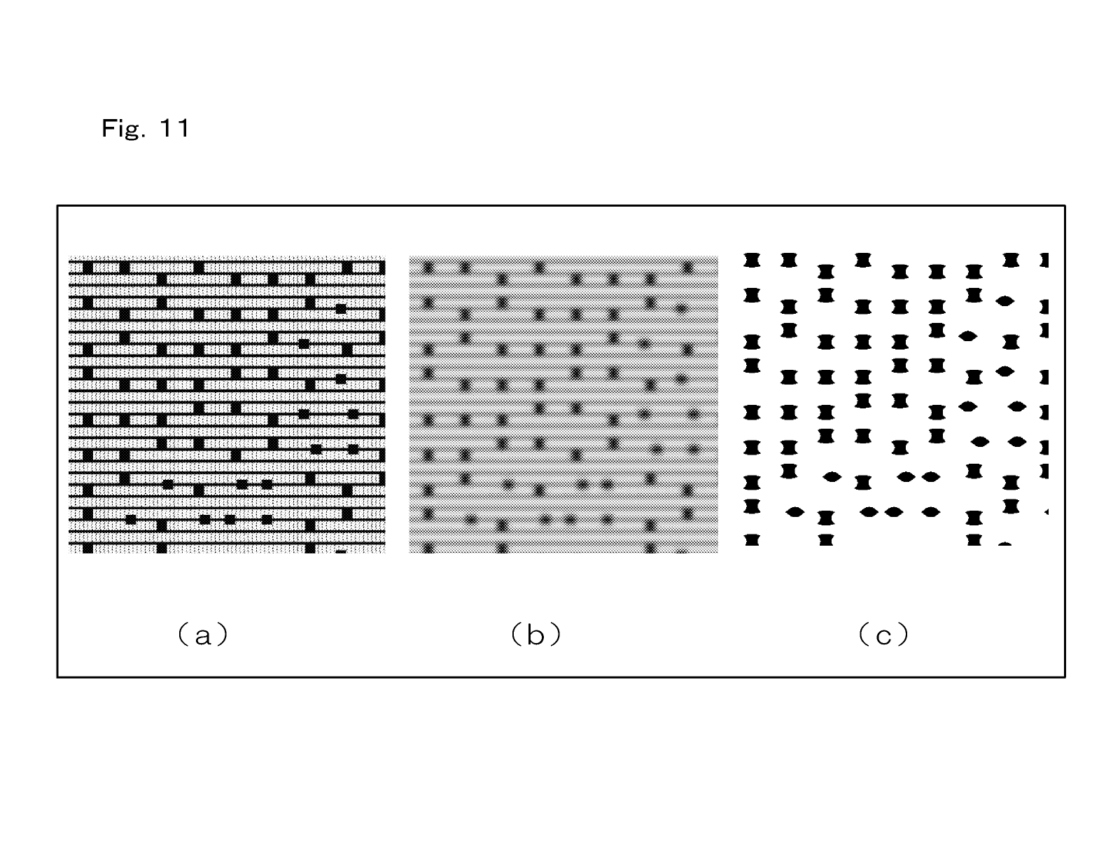

FIG. 11 is a diagram showing the positional relation between dot patterns and the black matrix 31 in a case where the pitch P between each first reference line 44 is three times that (an integral multiple) of the pitch Q between each first black line 31a.

FIG. 11(a) is a schematic diagram showing the dot patterns on the black matrix 31. FIG. 11(b) is a schematic diagram showing an image of the region shown in FIG. 11(a) which is captured by the digital pen 10. FIG. 11(c) is a schematic diagram after a binarization process is performed on the image in FIG. 11(b).

In the present embodiment, the pitch P between each first reference line 44 is set so as to be an integral multiple of the pitch Q between each first black line 31a. Thus, the dots 42 and the first black lines 31a regularly overlap each other. As a result, the shapes of the dots 42 are unlikely to become varied after the binarization process.

In addition, in the present embodiment, the pitch P between each first reference line 44 is equal to or larger than three times that of the pitch Q between each first black line 31a (is three times thereof in the present embodiment). Thus, it is possible to ensure a sufficient distance between the adjacent dots 42. As a result, as shown in FIG. 11(c), even after the binarization process, it is possible to suppress a phenomenon in which the adjacent dots 42 are connected to each other. However, when the pitch P between each first reference line 44 is excessively increased, the number of dots per unit area is decreased and hence the density of information is decreased. Therefore, the relationship between the pitch P between each first reference line 44 and the pitch Q between each first black line 31a is determined as appropriate on the basis of the size of the display surface of the display panel 24, an amount of information desired to be provided to each dot pattern, and the like.

As described above, according to the present embodiment, the pitch P between each first reference line 44 is set so as to be an integral multiple of the pitch Q between each first black line 31a. As a result, it is possible to obtain an appropriate image of a dot pattern, and thus it is possible to improve the accuracy of reading a dot pattern.

### Other Embodiments

As described above, Embodiment 1 has been described as an illustrative example of the technology disclosed in the present application. However, the technology in the present disclosure is not limited thereto, and is also applicable to embodiments in which changes, substitutions, additions, omissions, and/or the like are made as appropriate. In addition, each constituent element described in Embodiment 1 can be combined to provide a new embodiment.

Other embodiments will be described below.

Embodiment 1 has been described with the liquid crystal display as an example of the display device, but the display device is not limited thereto. The display device 20 may be a device capable of displaying characters or video, such as a plasma display, an organic EL display, or an inorganic EL display. In addition, the display device 20 may be a device whose display surface is freely deformed, such as electronic paper.

In addition, the display device 20 may be a display of a notebook PC or a portable tablet. Furthermore, the display device 20 may be a television, an electronic whiteboard, or the like.

In Embodiment 1, the optical film 40 on which the dot patterns are formed is arranged on the color filter 30, but the present disclosure is not limited thereto. The dots 42 may be formed directly on the color filter 30.

The digital pen 10 or the display device 20 may include a switching section that switches a process to be performed in accordance with an input of position information from the digital pen 10. Specifically, a switch may be provided in the digital pen 10 and may be configured to be switchable among input of characters or the like, deletion of characters or the like, movement of a cursor, selection of an icon, and the like. In addition, icons for switching among input of characters or the like, deletion of characters or the like, movement of a cursor, selection of an icon, and the like may be displayed on the display device 20 and may be selectable by using the digital pen 10. Furthermore, a switch corresponding to a right click or a left click of a mouse may be provided in the digital pen 10 or the display device 20. By so doing, it is possible to further improve the operability of the GUI.

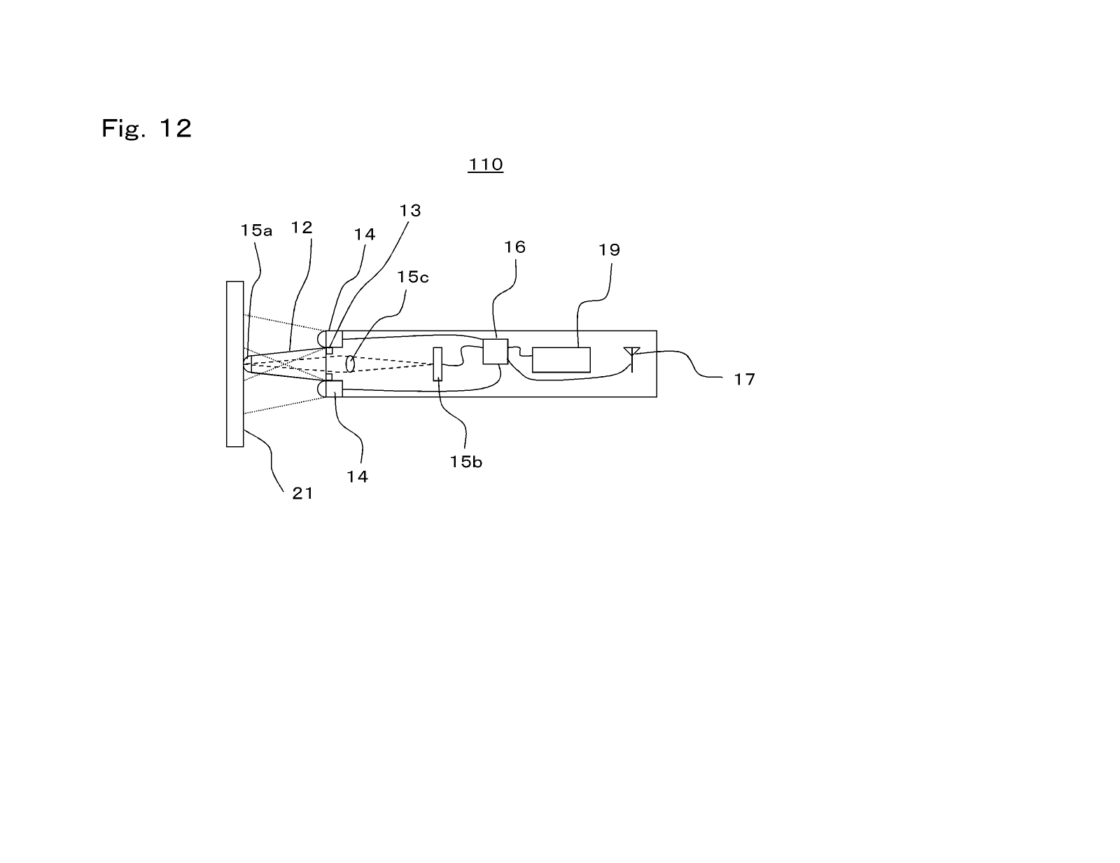

The configurations of the digital pen 10 and the display device 20 are examples, and the present disclosure is not limited thereto. FIG. 12 is a schematic cross-sectional view of a digital pen 110 according to another embodiment. For example, in the digital pen 110 shown in FIG. 12, the pen tip portion 12 is formed from a material that is able to transmit infrared light. The objective lens 15a is provided within the tip of the pen tip portion 12. The reading section 15 further includes a lens 15c within the body case 11, and the objective lens 15a and the lens 15c constitute an optical system. A plurality of (e.g., four) irradiation sections 14 are arranged at an end of the body case 11 so as to surround the pen tip portion 12. The number of the irradiation sections 14 may be set as appropriate. In addition, a single ring-shaped light may be provided as an irradiation section 14 so as to surround the pen tip portion 12. With this configuration, a point where the digital pen 110 comes into contact with the display section 21 substantially coincides with the position of the lens 15a of the reading section 15 which reads a dot pattern. Thus, it is possible to more accurately detect the position of the tip of the pen tip portion 12. As a result, the user is allowed to perform a handwriting input with the digital pen 110 as if actually writing with a pen.

Transmission and reception of signals between the digital pen 10 and the display device 20 are performed by means of wireless communication, but are not limited thereto. The digital pen 10 and the display device 20 may be connected to each other via a wire, and transmission and reception of signals may be performed via the wire therebetween.

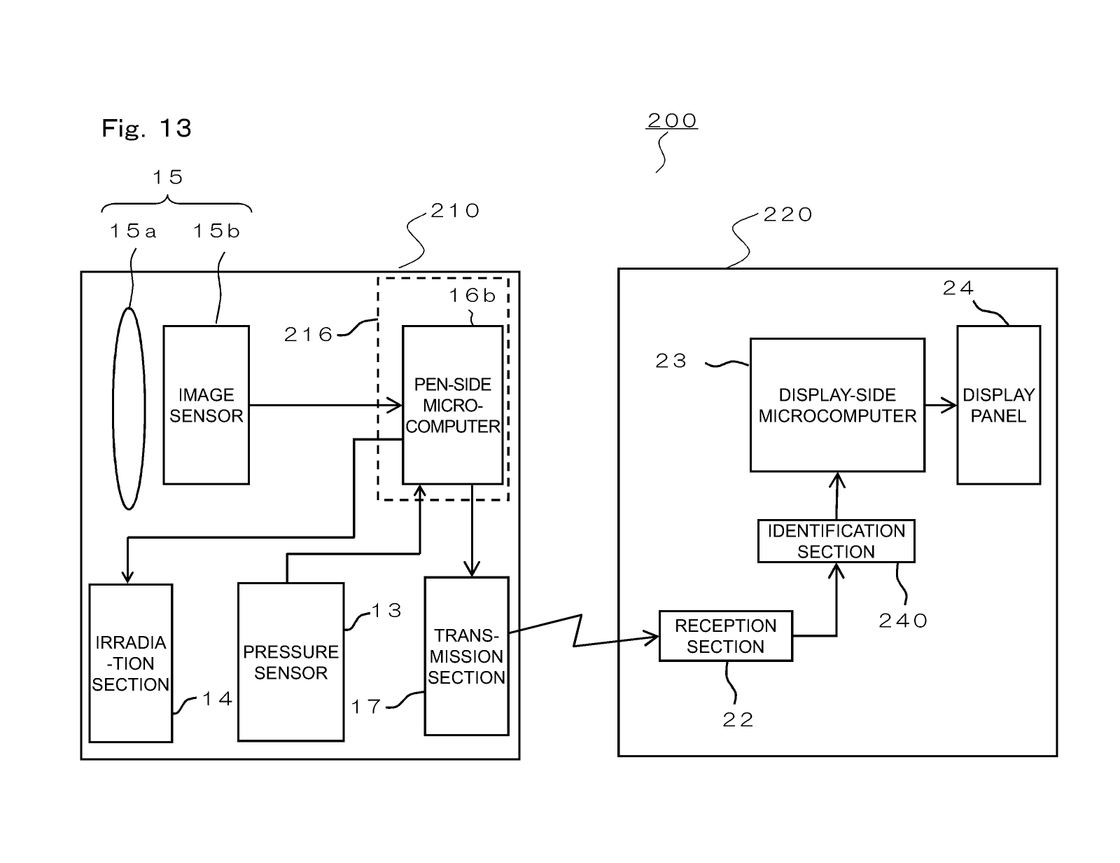

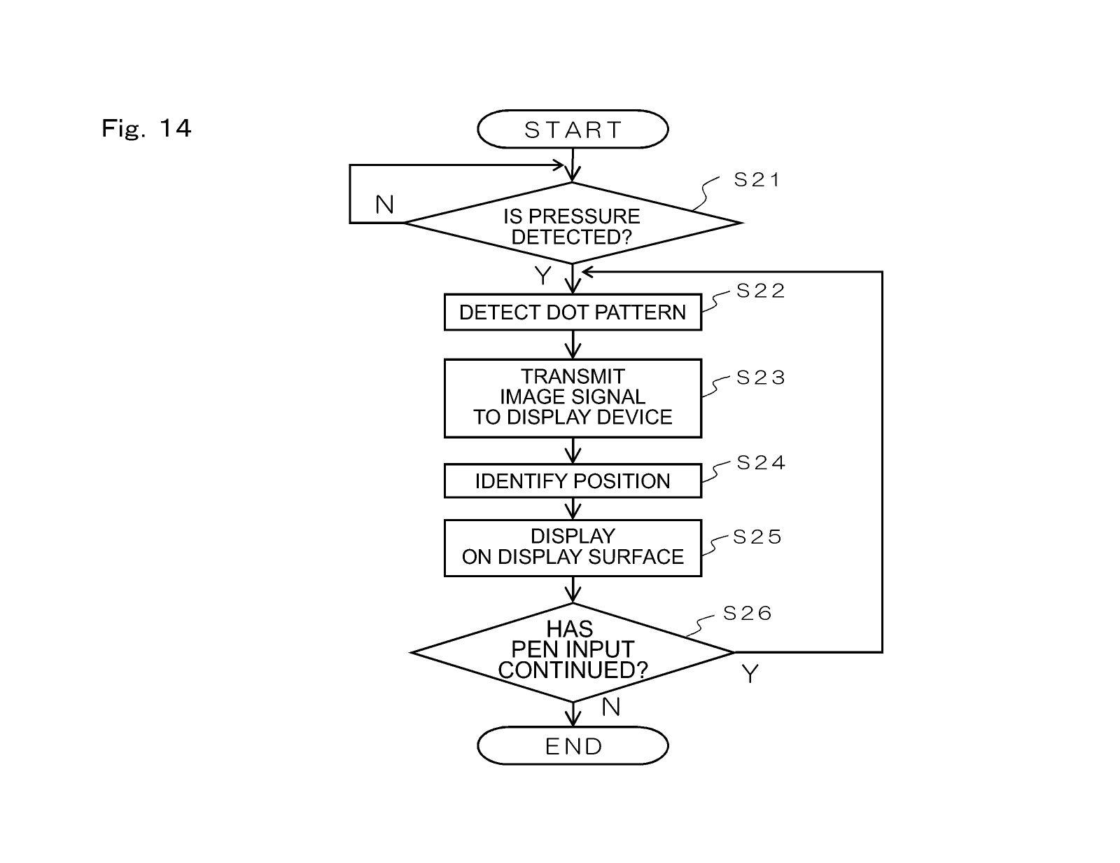

In Embodiment 1, the digital pen 10 identifies position information and transmits the position information to the display device 20, but the present disclosure is not limited thereto. FIG. 13 is a block diagram of a display control system 200 according to another embodiment. A digital pen 210 shown in FIG. 13 includes a pressure sensor 13, an irradiation section 14, a reading section 15, a control section 216, and a transmission section 17. The configurations of the pressure sensor 13, the irradiation section 14, the reading section 15, and the transmission section 17 are the same as those in Embodiment 1. The control section 216 includes a pen-side microcomputer 16b and does not include the identification section 16a in Embodiment 1. In other words, the control section 216 outputs an image signal inputted from an image sensor 15b, to the transmission section 17 without identifying position information of the digital pen 210 from the image signal. Thus, the image signal obtained by the image sensor 15b is transmitted from the digital pen 210. A display device 220 shown in FIG. 13 includes a reception section 22 that receives a signal from an external device, a display-side microcomputer 23 that controls the entirety of the display device 220, a display panel 24 that displays an image, and an identification section 240 that identifies the position of the digital pen 10. The configurations of the reception section 22, the display-side microcomputer 23, and the display panel 24 are the same as those in Embodiment 1.A plurality of dot patterns are formed in a display section 21 of the display panel 24. The reception section 22 receives an image signal transmitted from the digital pen 210 and transmits the received image signal to the identification section 240. The identification section 240 has the same function as that of the identification section 16a of the digital pen 10 in Embodiment 1. With this configuration, as shown in FIG. 14, the digital pen 210 obtains an image of a dot pattern with the image sensor 15b (step S22), and the image signal is transmitted from the digital pen 210 to the display device 220 (step S23). Then, the identification section 240 of the display device 220 identifies the position of the digital pen 210 from the image signal received from the digital pen 210 (step S24). The other processes are the same as in Embodiment 1.

It should be noted that in the digital pen 210 of the display control system 200, after an image of a dot pattern is obtained, image processing may be performed to reduce an amount of data, and then a signal resulting from the image processing may be transmitted to the display device 220. In other words, as long as the digital pen 10, 110, or 210 captures an image of a dot pattern representing information regarding a position, on the display section 21, which is pointed to by the digital pen 10, 110, or 210, information regarding the position on the display area may be transmitted in any form from the digital pen 10, 110, or 210 to the display device 20 or 220. The display device 20 or 220 performs various display control in accordance with the received information regarding the position.

The identification section that identifies the position of the digital pen on the display section 21 may be provided as a control device independent of the digital pen 10 and the display device 20. For example, in a display control system in which a digital pen is added to a desktop PC including a display (an example of a display device) and a PC body (an example of a control device), the digital pen may optically read a dot pattern formed in a display section of the display and may transmit the dot pattern to the PC body. Then, the PC body may identify the position of the digital pen from the dot pattern and may instruct the display to perform a process corresponding to the identified position.

In Embodiment 1, the pressure sensor 13 is used only for determining whether a pressure is applied, but the present disclosure is not limited thereto. For example, the magnitude of a pressure may be detected on the basis of a detection result of the pressure sensor 13. By so doing, it is possible to read continuous change in the pressure. As a result, on the basis of the magnitude of the pressure, it is possible to change the thickness or the color density of a line to be displayed through a pen input.

In Embodiment 1, presence/absence of an input with the digital pen 10 is detected with the pressure sensor 13, but the present disclosure is not limited thereto. A switch that switches between ON and OFF of a pen input may be provided in the digital pen 10, and when the switch is turned ON, it may be determined that a pen input is present. In such a case, even when the digital pen 10 is not in contact with the display surface of the display section 21, it is possible to perform a pen input. Alternatively, the display device 20 may vibrate the display surface of the display section 21 at a determined vibration frequency. In such a case, the display device 20 detects presence/absence of a pen input by detecting change in the vibration frequency which is caused by contact of the digital pen 10 with the display surface of the display section 21.

In Embodiment 1, each pixel region 32 is rectangular, but is not limited thereto. Each pixel region 32 may have a shape such as a triangle or a parallelogram, or may have a shape obtained by combining them. Each pixel region 32 may have any shape as long as the display device is able to output characters or video. In addition, the black matrix 31 may be changed as appropriate in accordance with the shape of each pixel region 32.

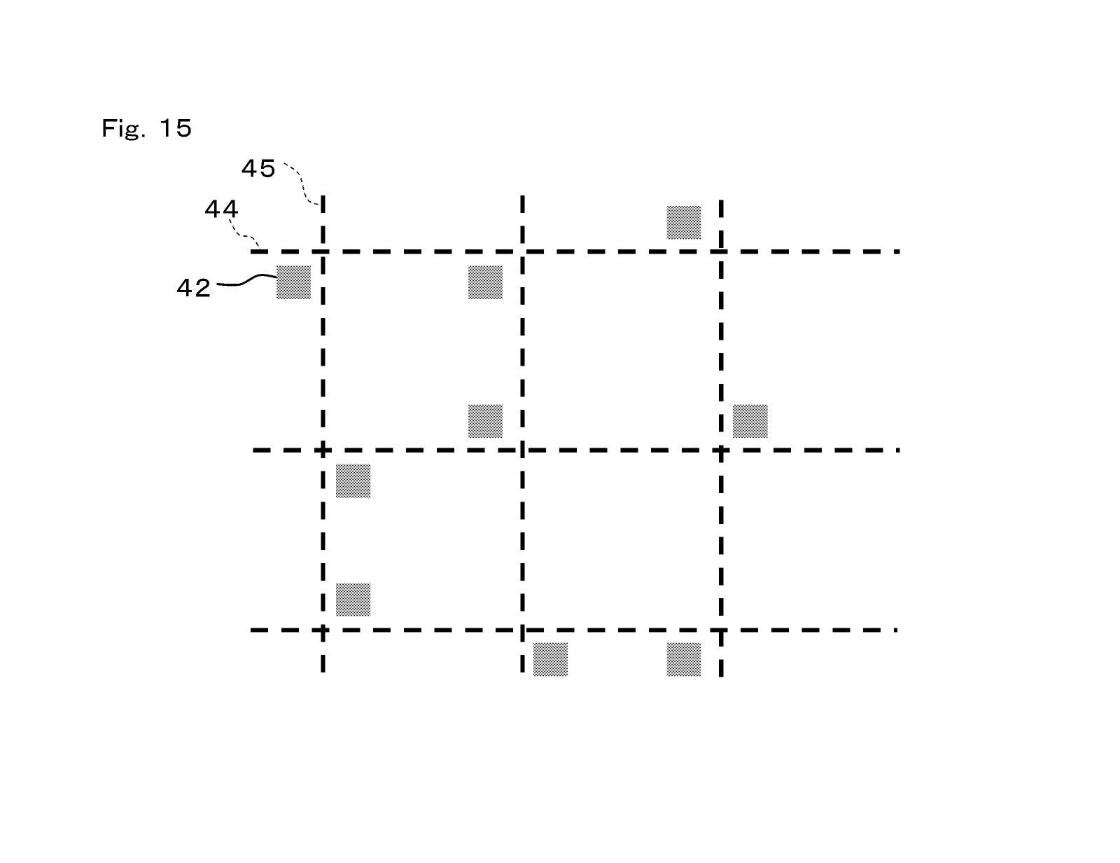

In Embodiment 1, each dot 42 is arranged on the first reference line 44 or the second reference line 45. However, as shown in FIG. 15, each dot 42 may be arranged at a position shifted from the intersection of the first reference line 44 and the second reference line 45 in an oblique direction with respect to the first reference line 44 and the second reference line 45.

The arrangement pattern of each dot 42 is not limited thereto. Any method may be used for coding of each dot pattern, and thus the arrangement pattern of each dot 42 may be changed in accordance with the used coding method.

The first reference lines 44 and the second reference lines 45 for arranging the dots 42 are not limited to those in Embodiment 1. For example, the first reference lines 44 may be defined on the black matrix 31 or may be defined on the pixel regions 32. Furthermore, it is possible to arbitrarily select what color of pixel regions 32 the first reference lines 44 are defined on. The same applies to the second reference lines 45.

In Embodiment 1, each dot pattern is formed in a unit area of 6 dots×6 dots, but is not limited thereto. The number of the dots constituting a unit area may be set as appropriate in accordance with the designs of the digital pen 10 and the display device 20. In addition, the configuration of each dot pattern is not limited to the combination of the arrangements of dots included in a determined area. The coding method is not limited to that in Embodiment 1 as long as each dot pattern is able to represent specific position information.

In Embodiment 1, each information pattern is composed of rectangular dots, but is not limited thereto. Each information pattern may be composed of a plurality of marks represented by figures such as triangles or characters such alphabets, instead of the dots. For example, each mark may be formed over the entirety of the pixel region 32.

The identification section 16a transforms a dot pattern to a position coordinate by calculation, but the present disclosure is not limited thereto. For example, the identification section 16a may previously store all dot patterns and position coordinates associated with the respective dot patterns and may identify a position coordinate by checking an obtained dot pattern against the relationships between the stored dot patterns and position coordinates.

As presented above, the embodiments have been described as an example of the technology according to the present disclosure. For this purpose, the accompanying drawings and the detailed description are provided.

Therefore, components in the accompanying drawings and the detail description may include not only components essential for solving problems, but also components that are provided to illustrate the above described technology and are not essential for solving problems. Therefore, such inessential components should not be readily construed as being essential based on the fact that such inessential components are shown in the accompanying drawings or mentioned in the detailed description.

Further, the above described embodiments have been described to exemplify the technology according to the present disclosure, and therefore, various modifications, replacements, additions, and omissions may be made within the scope of the claims and the scope of the equivalents thereof

What is claimed is:

1. A display panel having a display area for displaying an image, the display panel comprising:
a black stripe separating a plurality of pixels for forming a display image displayed on the display area; and
a plurality of information patterns arranged on the display area and each representing information regarding a position thereof on the display area, wherein
each information pattern is formed in a grid formed by using a plurality of virtual reference lines parallel to or substantially parallel to a plurality of black lines constituting the black stripe, by using a plurality of marks each arranged on the basis of a grid point in the grid as a virtual reference point,
the plurality of marks include a plurality of first marks each arranged at one side of a target direction, perpendicular to the virtual reference line, with respect to the virtual reference point and a plurality of second marks each arranged at another side of the target direction with respect to the virtual reference point, and
where a pitch between the virtual reference lines in the target direction is P; a width of the black line of the black stripe is W; a width of the first mark in the target direction is D1; a width of the second mark in the target direction is D2; a distance in the target direction from a center position of the first mark in the target direction to the virtual reference point of the first mark is S1; and a distance in the target direction from a center position of the second mark in the target direction to the virtual reference point of the second mark is S2, a relational expression of P>W+D1/2+D2/2+S1+S2 is met.

2. The display panel according to claim 1, wherein a relational expression of P>1.1×(W+D1/2+D2/2+S1+S2) is met.

3. The display panel according to claim 1, wherein
the width D1 of the first mark in the target direction is equal to the width D2 of the second mark in the target direction,
the distance Si in the target direction from the center position of the first mark in the target direction to the virtual reference point of the first mark is equal to the distance S2 in the target direction from the center position of the second mark in the target direction to the virtual reference point of the second mark, and
a relational expression of P>W+D1+2×S1 is met.

4. The display panel according to claim 1, wherein the pitch between the virtual reference lines is an integral multiple of a pitch between the black lines of the black stripe.

5. The display panel according to claim 1, wherein the pitch between the virtual reference lines is equal to or larger than three times that of a pitch between the black lines of the black stripe.

6. The display panel according to claim 1, wherein
the black stripe is a first black stripe,
the display panel further comprises a second black stripe perpendicular to the first black stripe, and
the black lines of the first black stripe is thicker than those of the second black stripe.

7. A display device comprising:
the display panel according to claim 1; and
a display control section configured to control the display panel.
